(19) United States
(12) Patent Application Publication
(10) Pub. No.: US 2022/0405793 A1
(43) Pub. Date: Dec. 22, 2022

(54) DISTRIBUTED NETWORK TRANSACTION SYSTEM WITH DYNAMIC COMMISSION PLANS

(71) Applicant: KwikClick, LLC, Murray, UT (US)

(72) Inventor: Fred Cooper, Farmington, UT (US)

(21) Appl. No.: 17/706,483

(22) Filed: Mar. 28, 2022

Related U.S. Application Data
(60) Provisional application No. 63/166,677, filed on Mar. 26, 2021.
(60) Provisional application No. 63/166,683, filed on Mar. 26, 2021.
(60) Provisional application No. 63/166,687, filed on Mar. 26, 2021.

(51) Int. Cl. G06Q 30/02; G06Q 30/06; G06Q 50/00

(52) U.S. Cl. CPC G06Q 30/0214; G06Q 30/0617; G06Q 50/01

(57) ABSTRACT

Disclosed are systems, apparatuses, processes, and computer-readable media for a distributed network transaction system with dynamic commission plans. A method of a distributor system includes receiving a transaction associated with an item provided from a third party; identifying a user associated with the transaction; identifying a commission plan for the item from a plurality of commission plans for the item, wherein the commission plan is configured by the third party; and determining a commission associated with the user based on the commission plan associated with the item. In one aspect, the method includes creating alternative commission plans and comparing transactions based on commission plans to identify correlations in commission plans and transactions.

### CROSS-REFERENCE TO RELATED APPLICATIONS

The present disclosure claims the priority benefit of U.S. provisional patent application No. 63/166,677 filed Mar. 26, 2021, U.S. provisional patent application No. 63/166,683 filed Mar. 26, 2021, and U.S. provisional patent application No. 63/166,687 filed Mar. 26, 2021, the disclosures of which are incorporated by reference herein.

### BACKGROUND OF THE INVENTION

### 1. Field of the Disclosure

The present disclosure is generally related to a distributed network transaction system with dynamic commission plan.

### 2. Description of the Related Art

A multilevel marketing (MLM) system is a sales strategy used by some direct sales companies, which is used to encourage existing distributors to recruit new distributors who are paid a percentage of their recruits' sales. The recruits are the distributor's “downline.” Distributors also make money through direct sales of products to customers. Amway, which sells health, beauty, and home care products, is an example of a well-known direct sales company that uses multilevel marketing.

### SUMMARY OF THE CLAIMED INVENTION

Disclosed are systems, apparatuses, processes, and computer-readable media for a distributed network transaction system with dynamic commission plans. A method of a distributor system includes receiving a transaction associated with an item provided from a third party; identifying a user associated with the transaction; identifying a commission plan for the item from a plurality of commission plans for the item, wherein the commission plan is configured by the third party; and determining a commission associated with the user based on the commission plan associated with the item. In one aspect, the method includes creating alternative commission plans and comparing transactions based on commission plans to identify correlations in commission plans and transactions.

### BRIEF DESCRIPTION OF THE DRAWINGS

FIG. 1 illustrates an exemplary network environment in which a distributed network transaction system with dynamic commission plans may be implemented.

FIG. 2 is a block diagram of an exemplary distributor system for distributed network transactions.

FIG. 3 illustrates a flowchart of an exemplary method performed by a distributor base module to determine synchronize data across the MLM system.

FIG. 4 illustrates a flowchart of an exemplary method performed by a calculation module.

FIG. 5 illustrates a flowchart of another exemplary method performed by a calculation module.

FIG. 6 illustrates a flowchart of an exemplary method performed by an advertising module of the distributor system.

FIG. 7 illustrates a flowchart of an exemplary method performed by a third-party data module of the distributor system.

FIG. 8 illustrates a flowchart of an exemplary method performed by a plan generation module of the distributor system.

FIG. 9 illustrates a flowchart of an exemplary method performed by a plan analysis module of the distributor system.

FIG. 10 shows a block diagram of an exemplary user device configured to create transactions based on the distributor system.

FIG. 11 illustrates a flowchart of an exemplary method performed by a purchase module.

FIG. 12 illustrates a flowchart of an exemplary method performed by a downline module.

FIG. 13 illustrates a flowchart of an exemplary method performed by a social media search module.

FIG. 14 illustrates a flowchart of an exemplary method performed by a distributor system to permit a user device to access various user modules of the distributor system.

FIG. 15 illustrates a flowchart of an exemplary method performed by a user activity module of distributor system.

FIG. 16 illustrates a flowchart of an exemplary method performed by a suggested features module of user system.

FIG. 17 shows a block diagram of an exemplary third-party system configured to enroll products and services into a distributor system.

FIG. 18 illustrates a flowchart of an exemplary method performed by a third-party base module of third-party system.

FIG. 19 illustrates a flowchart of an exemplary method performed by a distributor registration module.

FIG. 20 illustrates a flowchart of an exemplary method performed by a discount module of third-party system.

FIG. 21 is a diagram illustrating an exemplary of a system for implementing certain aspects described herein.

### DETAILED DESCRIPTION

MLM is a legitimate business sales strategy. One problem is that the MLM is organized as a pyramid tree. However, pyramid “schemes” that use money from new recruits to pay people at the top rather than those who perform the work is illegal. These pyramid schemes involve taking advantage of people by pretending to be engaged in legitimate multilevel or network marketing. Pyramid schemes can be identified by their greater focus on recruitment than on product sales.

One issue in determining the legitimacy of an MLM company is whether the MLM sells the products primarily to consumers or to its members who must recruit new members to buy their products. If the MLM sells products to consumers, the company is likely a legitimate multilevel marketer, and if the MLM sells products to members to recruit members, the MLM may be an illegal pyramid scheme.

Although each MLM company dictates its own specific financial compensation plan for the payout of any earnings to their respective participants, the common feature that is found across all MLMs is that the compensation plans theoretically payout to participants only from two potential revenue streams. The first revenue stream is paid out from commissions of sales made by the participants directly to their own retail customers. The second revenue stream is paid out from commissions based upon the wholesale purchases made by other distributors below the participant who have recruited those other participants into the MLM. In the organizational hierarchy of MLMs, these participants are referred to as a downline distributor.

MLM salespeople (distributors) are, therefore, expected to sell products directly to end-user retail consumers by means of relationship referrals and word of mouth marketing, but most importantly they are incentivized to recruit others to join the company's distribution chain as fellow salespeople so that these can become downline distributors.

Currently, in order to join an MLM, there is an initiation fee, which is a barrier against those that just wish to refer to a single product they like. Current MLM systems do not take full advantage of the internet and how consumers can influence other consumers to make purchases. Also, current MLM systems do not incorporate incentivizing users of a multi-level marketing system by offering a dynamic commission tree. In addition, there is no current MLM system that utilizes the money or funds dedicated to discounts or coupons to be reincorporated into a multi-level marketing system to incentivize consumers to make purchases and advertise the product that they purchased. Further, a member of an MLM may rely on their sponsor or upline to teach them how best to distribute products. This relationship is the same for each product within the MLM's distribution network. However, in a single-product-based MLM system, one user may have as many immediately upline users as products.

This system has value because it allows the MLM system to quickly direct users to useful features and allow them to most effectively distribute recently purchased products without needing to rely on the advice and experience of an established upline user.

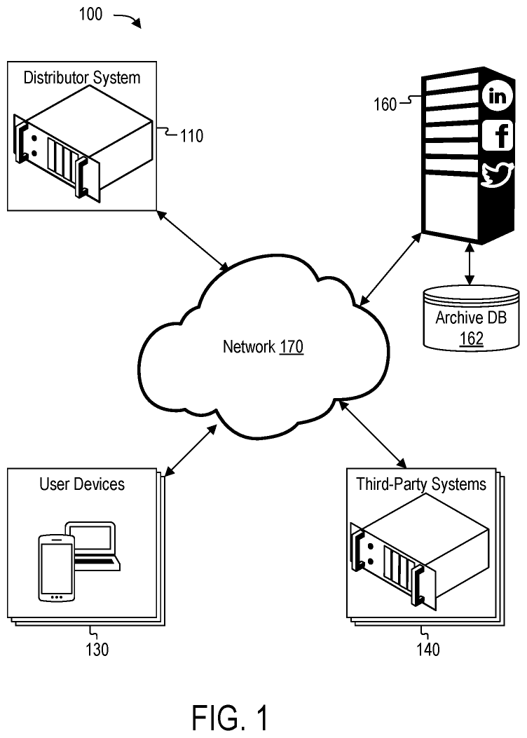

FIG. 1 illustrates an exemplary network environment in which a distributed network transaction system with dynamic commission plans may be implemented. In some aspects, the system can be implemented as an MLM system 100 that includes multiple participants including a distributor system 110, at least one user device 130, a third-party system 140, and a social media system 160 that communicate using a network 170. Various aspects of the distributor system 110, a user device 130, a third-party system 140 are described below and with reference to accompanying figures.

In some aspects, the distributor system 110 comprises a plurality of devices and for distributing and automating functions associated with the MLM in a more efficient and a transparent manner. In the illustrative example in FIG. 1, the distributor system 110 is associated with a centralized distribution system coordinating marketing efforts to engage customers and sell services and products associated with the third-party system 140 with one or more users (or vendors) associated with a user device 130. In some aspects, the distributor system 110 coordinates payments amongst one or more users of the distributor system 110 associated with a transaction, and can provide other functionality such as creation of commission plans as described herein. In some aspects, the distributor system 110 may be able to enroll third parties that must be efficient with resources and improve distribution, advertising, and market visibility. The distributor system 110 also provides technical benefits based on the coordinating technology described herein to link to different services to simplify creation of electronic websites for small third-party producers and services. The instant disclosure provides the technical details that identify integration points of various services for smaller third parties to reduce capital expenditures to allow third parties to focus on core business assets.

In some aspects, the distributor system 110 may coordinate with various parties to provide goods and services through various entities and individual users (or vendors). For example, an entity may be (describe the entity) and an individual user may be a non-salaried contractor who sells an entity's products or services, while the earnings of the user are derived from a pyramid-shaped or binary compensation commission system. For example, a user may sell a product may such as an article, device, or substance that is manufactured, assembled, produced, or refined for sale. A user may also perform or enable a function such transportation, communications, or utilities such as electricity or water. In one aspect, a third party system may provide a physical service such as plumbing or electrical repair, may provide a telecommunications service, or may sell physical goods. In some aspects, the user (or vendor) may enable services such as schedule jobs for another third-party, who perform a type of work such as construction, automotive repair, cleaning services, and so forth.

In some aspects, the MLM system 100 may be configured to provide a commission (e.g., payment) based on an MLM tree or commission tree. In some cases, an MLM system may be referred to as network marketing business that uses person-to-person sales by independent representatives, often working from home, to sell and provide goods and services. A network marketing business may require independent representatives to build a network of business partners or salespeople to assist with lead generation and closing sales. The end of life of the MLM tree may refer to the end of the MLM tree in which further participants in the MLM will not receive a commission, the commission tree starts up again, or the commission tree is restructured in some form. An existing MLM system may refer to currently existing or established legal entities that use the sales strategies to encourage existing distributors to recruit new distributors who are paid a percentage of their recruits' sales.

In some embodiments, the distributor system 110 may protect data from unauthorized access and data corruption throughout the lifecycle of that data. For example, the data can be secured by data encryption, tokenization, and secure key management practices to protect data across all applications and platforms. The distributor system 110 may be configured to execute all or part of an MLM algorithm to calculate a compensation decay rate and determine commissions for downline participants. In some aspects, the MLM system 100 may be configured to connect to an app store for various functions such as authenticating hardware, authenticating payments, application distribution, and so forth.

The distributor system 110 is configured to communicate with the user system 120, the third-party system 140, and the social media system 160 through a network 170 such as a wired network or a wireless network. In some cases, the network 170 may use a public network such as the internet to communicate with other systems. In other aspects, the network 170 may be a private network that is implemented, for example, in a private cloud-based network and connects to various services such as the social media system 160. Examples of wireless communication techniques include Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art. The communication network may allow ubiquitous access to shared pools of configurable system resources and higher-level services that can be rapidly provisioned with minimal management effort, such as the Internet, and shares resources to achieve coherence and economies of scale, like a public utility, while third-party clouds enable organizations to focus on core business functions instead of expending resources on computer infrastructure and maintenance.

In some aspects, the MLM system 100 may be configured to interact with at least one user device 130 such as a laptop, smartphone, tablet, computer, or smart speaker that may include various hardware devices configured to perform wireless or wired communication using the network 170.

In some aspects, the distributor system 110 is configured to engage with at least one third-party system 140, which can include various retailers or service providers that can enroll some or all of their products or services within the distributor system 110. The distributor system 110 may create proprietary information that the third-party system 140 can store for enabling purchases by user device 130 to qualify for commissions. The distributor system 110 can receive the various information from the user device and the third-party system 140 to calculate commissions based on various parameters such as decay rate, initial commission, and so forth. The distributor system 110 can also dynamically build commission plans and track sales to identify parameters and other information using machine learning (ML) and other data science techniques to maximize sales performance for participants (e.g., vendors, third-party entities, etc.).

The MLM system 100 may be configured to engage with at least one social media service 160 (e.g., Twitter, Facebook, Linkedln, TikTok, etc.) for analyzing data that is available to a user. In some cases, the user device 130 may be configured to access the social media service 160 based on an application or software module that accesses a user account associated with the user device 130 to identify various available content that can be linked to products or services associated with the distributor system 110.

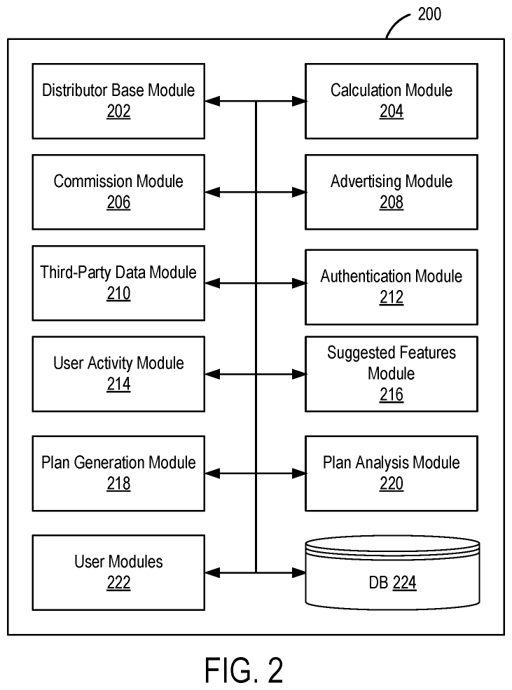

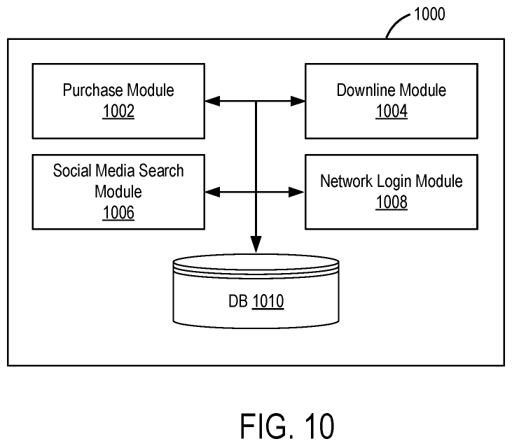

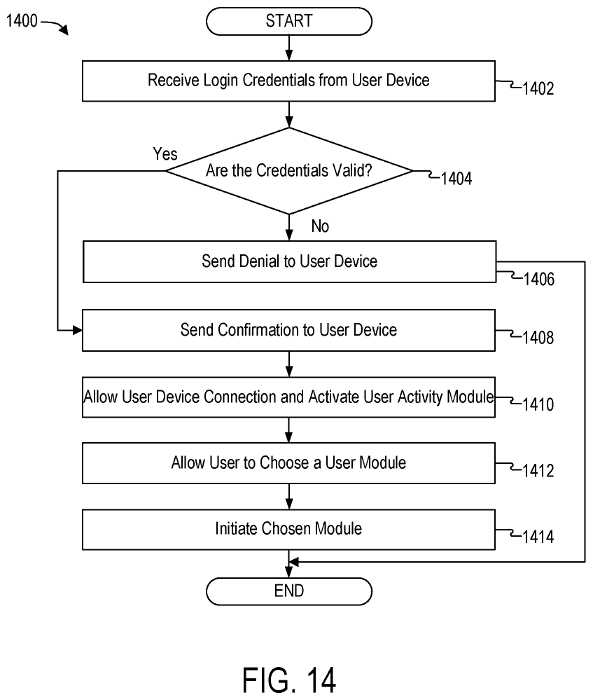

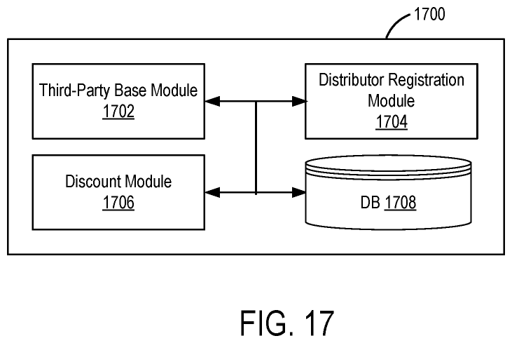

In various aspects, FIGS. 2-9 describe further aspects of the distributor system 100, FIGS. 10-13 describe further aspects of the user device, FIGS. 14-16 describe various functions that are enabled by the combination of the user device and the third-party system, and FIGS. 17-20 describe further aspects of the third-party system.

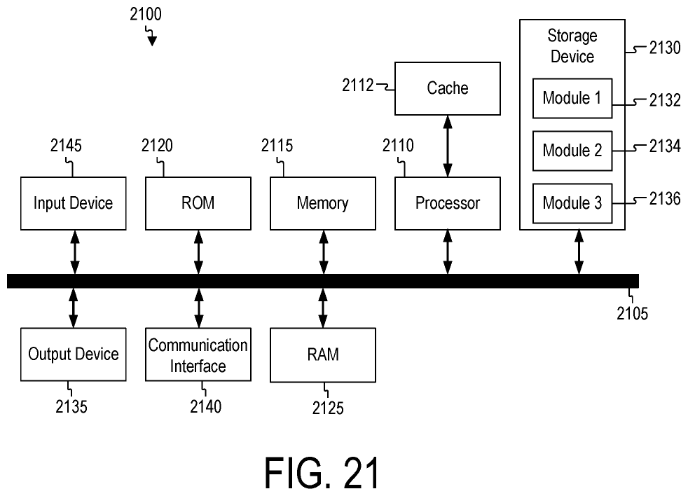

FIG. 2 is a block diagram of an exemplary distributor system 200 for distributed network transactions. In some aspects, the distributor system 200 is configured to perform one or more of the methods or processes described herein. In one aspect, the distributor system 200 may be implemented in whole or in part by at least one computing system, such as the computing system 2100 illustrated in FIG. 21. The distributor system 200 may include at least one communication module that is configured to communicate over a public or private network, either through wired or wireless techniques, to exchange information to perform the various methods described herein.

Distributor system 200 may be configured to coordinate sales, payments, and distribution of goods and services according to some aspects. In some aspects, the distributor system 200 is configured to perform one or more of the methods or processes described herein. In one aspect, the distributor system 200 may be implemented in whole or in part by at least one computing system, such as the computing system 2100. The distributor system 200 may include at least one communication module that is configured to communicate over a public or private network, either through wired or wireless techniques, to exchange information to perform the various methods described herein.

In some aspects, the distributor system 200 may include a distributor base module 202, a calculation module 204, a commission module 206, an advertising module 208, a third-party data module 210, an authentication module 212, a user activity module 214, a suggested features module 216, a plan generation module 218, a plan analysis module 220, various user modules, and a database 224. In some aspects, the database 224 is illustrative and the distributor system 200 may include a number of data storage mechanisms and may use a database (e.g., a SQL database) that can store a plurality of databases, and each database can include at least one table. The storage of the distributor system can have a normalized (e.g., a structured query language (SQL) database) or an unnormalized form (e.g., a document database).

The distributor base module 202 may be configured to perform base functionality of the system and coordinate with different systems to perform the various functions described here. For example, the distributor base module 202 may connect to another entity's system (e.g., third-party system 140) for performing various functions associated with the other entity, such as using the calculation module 204 to calculate various costs of goods using a decay rate. For example, the distributor base module 202 may request a discount module of the third-party system 140 to determine a discount associated with a product or service. The distributor base module 202 may receive the discount information from the third-party system 140 and provide the information to the calculation module 204 to identify a compensation plan or commission plan (e.g., a decay rate or a commission structure so that each downline receives increasingly less commission) associated with commissions for the MLM based on the discount. In this case, a commission refer to a payment to any person or entity that sells goods or services associated within the context of the distributor system 200. In some embodiments, a compensation plan or a commission plan may refer to the decay rate of the commissions provided to the MLM system based on the discount offered by the third-party system 140. In some aspects, the third-party system 140 mays also select a decay rate to calculate the commissions offered to the first purchaser as well as the percentage offered to the downline participants.

A commission module 206 may be configured to request the discount module of the third-party system (e.g., third-party system 140) for user data, with the user being the product purchaser or distributor. For example, the commission module 206 may request user data associated with an individual user or vendor that provides goods or services associated with the third-party system 140. In response to receiving the user data, the commission module 206 retrieves compensation data stored in the database 224 to determine the downline and upline commissions for other users (e.g., product purchasers or distributors) within the MLM tree. In some embodiments, an upline refers to the MLM distributors that recruits work for as salespeople to sell products or services, and a downline refers to the recruits the MLM distributors are able to secure as participants in the MLM system.

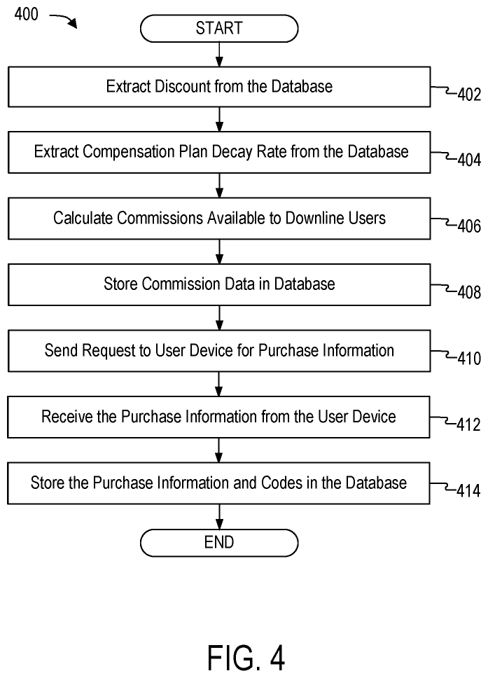

In some cases, downline trees may cross country boundaries which may limit the ability to pay out commissions for an MLM tree even though the participants in the MLM tree may not reside in the same country. In this case, the commission module 206 may be configured to calculate for the appropriate exchange rate to ensure participants are paid in their residing country's currency in the correct amount. Aspects of the commission module are further described herein with reference to FIG. 4.

In some aspects, the advertising module 208 is configured to determine the sphere of influence or contact list of an individual user to provide the user's potential downline consumers (e.g., users, vendors, or purchasers) with a link and a code to become part of the MLM tree. In some aspects, an advertising link directly link to provide textual or multimedia information related to a product, service, or good to a consumer.

The distributor system 200 may include a entity data module 114 that receives data from another entity (e.g., third-party system 140). The entity data module may store the data in the database 224, create a link for the item, and send the link back to the third-party system 140.

In some aspects, the distributor system 110 may include an authentication module 212 for authenticating user to access various modules of the distributor system 110, and a user activity module 214 for recording user activity on the distributor system 110. In some cases, the authentication module 212 can be scaffolded in from another authentication system (e.g., Okta, Identity, etc.). In other aspects, the authentication module 212 functions can integrate with other authentication systems such as Google, Facebook, Apple, etc. The distributor system 110 may also include a suggested features module 216 which may use the data of the user activity module 214 to determine modules are most often accessed by users who have purchased a product. When a new user purchases a product, the module may send that uses the most accessed modules by other users who have purchased the same product

The distributor system 110 may include other user modules 222 that are useful to the user and may be accessed by the user after logging into the distributor system 110. Some or all features of these modules may be restricted from some users. The user modules can include a smart link module which may receive a media file from the user device identifies the associated product, compares the product to the products in a database, determines if there is a match and embeds a smart link to the media file, and sends the updated media file back to the user device with the smart link embedded in the media file. The user modules can include a sharing module which allows a user to automatically share a media file with an embedded smart link to a selected social media page by allowing the user to publish the media file on social media. The smart link contains the product code which will direct anyone who interacts with the media file to the specified page, usually, the product purchase page records the identification of the user who shared the media file, and determines if a purchase was completed.

The user modules can include a viewing module which creates a visual representation of a user's commission tree for a selected product and allows the user to interact with individual users or the tree as a whole. An advertisement Sharing Module which allows a user to share advice, information, strategy, etc. with all or a subset of a user's downline, and allows users to receive the same from their upline. A communication module allows users to attempt to contact downline users directly, allows downline users to accept the contact, and then allows those users to communicate. A review module that allows the user to rate and review service, user, or a third-party that they have personally interacted with via the distributor system 110. The module may be initialized by the user or may be initiated when an event occurs, for example, the module may prompt the user to rate and review when the user makes a purchase, a sale to a downline user, 3 days after purchase, when at least 5 downline users have purchased a service, when a third-party has sold 1000 units of service and the user was a purchaser, etc. The module may also allow users and third parties to view the reviews of other users, at element 140.

A second MLM synergy module which may detect potential conflicts between products registered with the MLM system and products registered with a second MLM system. The second MLM synergy module may then resolve these conflicts. The method of resolving these conflicts may be decided by the MLM system, the second MLM system, or both. An second MLM commission module may determine if a user is enrolled in a second MLM system or if a member of the user's downline is involved in the second MLM system. The module may then adjust commission based on the user's participation in the second MLM, or commissions earned from downline purchasers that are members of the second MLM.

A refund module may be initiated when a product with a discount code from the code database is returned. If applicable to that product, the refund module identifies the commissions paid out by the commission module to users, the upline and downline users who also were paid a commission, utilizes the decay rates in the compensation database to properly debit the user the commission initially credited to them, at element 146. An jurisdiction module may detect a user's location from the user device and determines what jurisdiction that location corresponds to, then the jurisdiction module initiates the language module, currency module, and law module, and sends each user's current jurisdiction's language(s), currency and exchange rate, and minimum and maximum compensation decay rate, respectively. An language module which determines which language or languages are spoken in the user's current jurisdiction. The user may be prompted to choose a language from multiple spoken in the region. The user may be prompted to change languages when they move from one jurisdiction to another. The language may be used by other modules, for example, the smart link module may link to a different landing page based on the language of the jurisdiction, at element 150.

A currency module determines the currency used in the user's current jurisdiction and changes the user's amount of credit, payouts, a commission earned, etc. to that currency. An law module which alters the compensation of users in jurisdictions that have restrictions on MLM behavior, if the existing decay rate is outside the range of allowed rates, then the decay rate in the compensation database may be changed for that user, the allowed decay rate may have to be calculated from another legal requirement. For example in a jurisdiction, if MLMs are restricted to 3 levels of commissions from referrals then the decay rate would have to be calculated such that after the 3rd level or referrals the commission drops to 0 or to a number close enough to 0 that the user receives no commission. An Ad Building Module which may allow a user to filter and search for the most successful ads based on their filters. The ad building module may also allow the user to use parts from those ads, other media files, or both to create their ad. An social media group module which may allow a user or group of users to create a social media group or page tied to a product or group of products. Users may be able to set the group up so that only users who have purchased the associated product may contribute or otherwise interact with the group.

A social media connection module which may suggest connections via social media to users based on existing connections within the MLM system. For example, a user who often purchases products advertised by a second user may be suggested to connect with a third user who is directly upline of the second user. For another example, two users who often purchase products advertised by the same user may be suggested to connect, at element 160. A charity module which may allow a user to assign a portion or all of their commission to a charity. users may have multiple charities and commission on selected products may be allocated to selected charities. An alternate plan module may allow a user to select from a number of commission plans purchasing or advertising a product. For example, one plan may give the user a larger upfront discount but may pay less in commissions than another plan, at element 164. A suggestive selling module which allows users to view products that are often purchased together with products they have purchased. Users may want to purchase these items for themselves or for the sake of being able to advertise two or more products that are often purchased together, at element 166. A single-line module which allows users to enter into a single-line commission structure for eligible products. The single-line commission structure is one wherein the user's position in the tree is based on the time of purchase instead of which user referred to the product, at element 168. A reward module which rewards a user with one or more types of rewards. Types of rewards include, but are not limited to, cash, credit, gift cards or gift card balance, airline miles, third party points or credit, in-game currency, in-game rewards, cryptocurrency, lottery entry, discounts, stocks, bonds, physical gifts, or any other type of reward or incentive known in the art. An Admin Network master database which may store data relevant to the functioning of the User Modules. The Admin network master database may include multiple datasets or databases.

The database 224 is configured to store various normalized or unnormalized data in connection with operation of the distributor system. The database 224 may store the data received from various users that are part of the MLM and include various parameters such as an item ID, a description of the item, the original cost of the item, the discount for the item, the cost of the item with the discount, the compensation plan decay rate, and a link to the item. In some aspects, an advertising link directly link to presents a product, service, or good to a consumer. Examples databases (e.g., a table within an SQL database) or a collection (e.g., a document database) includes compensation database, a code database, a user activity database, and an authentication database.

The compensation database may be created based on execution of the calculation module 204 and may contain the various commissions for the individual users. The code data may store codes that an upline user may provide to another potential user (e.g., downline users or consumers) to advertise or promote the item that the upline or downline user has purchased.

In some aspects, at least some of the modules 202, 204, 206, 208, 210, 212, 214, 216, 218, 220, and 222 are implemented at least in part as software stored in a memory. For example, portions of one or more of the modules 202, 204, 206, 208, 210, 212, 214, 216, 218, 220, and 222 can be implemented as non-transitory instructions (or “code”) executable by at least one processor to perform the functions or operations of the respective engine. In some cases, at least some of the modules 02, 204, 206, 208, 210, 212, 214, 216, 218, 220, and 222 may be implemented by a circuit, such as an application specific integrated circuit (ASIC) or programmable circuit such as a functional programmable gate array (FPGA).

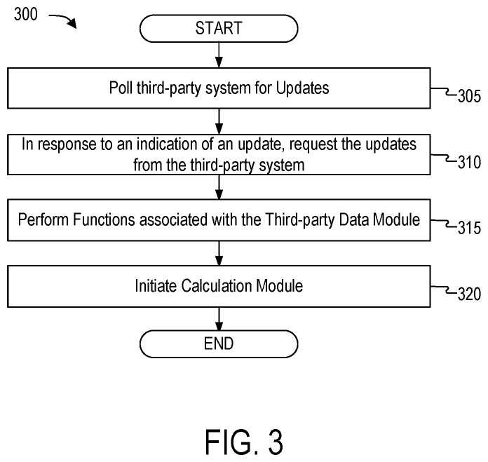

FIG. 3 illustrates a flowchart of an exemplary method performed by a distributor base module (e.g., distributor base module 202) to determine synchronize data across the MLM system. For example, the method 300 illustrated may be executed by a computing system (e.g., computing system 2100) to synchronize data and perform functions associated with the distributor system, such as calculating compensation for various parties.

In one illustrative example, at block 305, the method 300 includes continuously polling (e.g., by the computing system) the third-party system (e.g., third-party system 140) for updates to products, sales, and so forth. The computing system may receive an indication of an update at block 310, and, in response, the computing system may request the update from the third-party system. After the receiving the updates, which can include new products or services to be added to the distributor system, the computing system may perform the function associated with the third party data module at block 315. For example, as described above, the third party data module 210 may receive data regarding new products or services to enroll from another entity, perform functions needed to make the products or services available through the MLM, and provide information to the third party system regarding the enrollment. At block 320, the computing may perform functions associated with the calculation module 204, such as calculating the commissions available to users, and is further described below in connection with FIG. 4.

FIG. 4 illustrates a flowchart of an exemplary method performed by a calculation module 204. For example, the method 400 illustrated may be executed by a computing system (e.g., computing system 2100) to calculate compensation for various parties.

In some aspects, the distributor base module 202 may request the calculation module 204 to calculate compensation for the various parties based on updates. In response, the distributor base module 202 may cause the computing system to execute calculation module 204 to perform the method 400, which includes extracting (e.g., by the computing system) the discount that is stored in the database (e.g., database 224) associated with the items or various parties.

The computing system extracts the compensation plan decay rate from the database at block 404. At block 406, the computing system determines the commissions available to the downline users, or the followers of the user that purchased the item. In one illustrative example, the commissions may be calculated by using the discount on the item and providing 50% of the discount to the first user and then the remaining amount of the discount for the downline users at a 50% decay rate. For example, if the first user purchased an item that was originally $59.00 discounted by 15%, the first user to make the purchase would receive $4.42 or 50% of the discount. Then any follower of the user who made the initial purchase would receive 50% of the remaining discount or 50% of $4.42, and this may continue until there is only one cent left to pay out as a commission for the downline users.

After calculating the commissions available to downline users, the computing system may store the commission data in the compensation table in the database at step 408.

The computing system sends a request to a user device for purchase information associated with a purchase through the MLM system at step 410. In one aspect, the purchase information can include a code that identifies at least one good or service of the purchase. At block 410, the computing system receives the purchase information including any codes. In response to the purchase information, the computing system stores the received purchase information, as well as the code data, in the database at step 414.

Table 1 below illustrates an example table that is created and populated using the third party module. The third party module receives the item data from the third party entity, creates a link for the item, stores the data in the database, and sends the created link back to the third party. The database illustrated in Table 1 contains the data collected from various third parties enrolled in the dynamic distribution scheme than includes some features related to MLM such as the name of the third party, the ID for the item, a description of the item, the original cost of the item, the discount provided by the third party, the cost of the item with the discount, the compensation decay rate or how the downline commissions are calculated, and the link to the item.

TABLE 1

| | | | | | | Com- | |
|---|---|---|---|---|---|---|---|
| | | | | | Dis- | pensation | |
| 3rd | | | Original | Dis- | count | Decay | |
| Party | ID | Item | Cost | count | Cost | Rate | Link |
| Home | 654123 | Drill | $59.00 | 15% | $50.15 | 50% | HDDrill654123 |
| Depot | | | | | | | |
| Home | 789654 | Table | $119.00 | 10% | $107.10 | 50% | HDTSaw789654 |
| Depot | | Saw | | | | | |
| Furniture | 123789 | Couch | $999.00 | 10% | $899.10 | 30% | FSC123789 |
| Store | | | | | | | |
| Pharmacy | 456812 | Cold | $25.00 | 5% | $23.75 | 50% | PCM456812 |
| | | Medicine | | | | | |

In some aspects, the database may include communicating events with the downlines and uplines, dynamic incentives and rewards for a product, marketing materials, banking referrals, materials for suggestive selling, etc. The distributor system may communicate events with downlines and uplines refer to advertising events to participants in an MLM system. In some aspects, dynamic incentives and rewards for a product may refer to incentives or rewards that are continuously updated for a product. In some aspects, marketing materials may refer to a means of marketing, advertising, or promotional materials developed by or for a license (or subject to licensee's approval) that promote the sale of the licensed product, including but not limited to, television, radio and online advertising, point of sale materials (e.g. posters, counter-cards), packaging advertising, print media and all audio or video media. In some aspects, banking referrals may refer to a structured flow of collecting and organizing referrals for banks. Businesses who have been unsuccessful in a credit application process with a bank will be asked for their permission to have their financial information passed to designated finance platforms that can contact the business in a regulated time frame. In some aspects, suggestive selling may refer to a sales technique where an employee asks a customer if they would like to include an additional purchase or recommends a product that might suit the client.

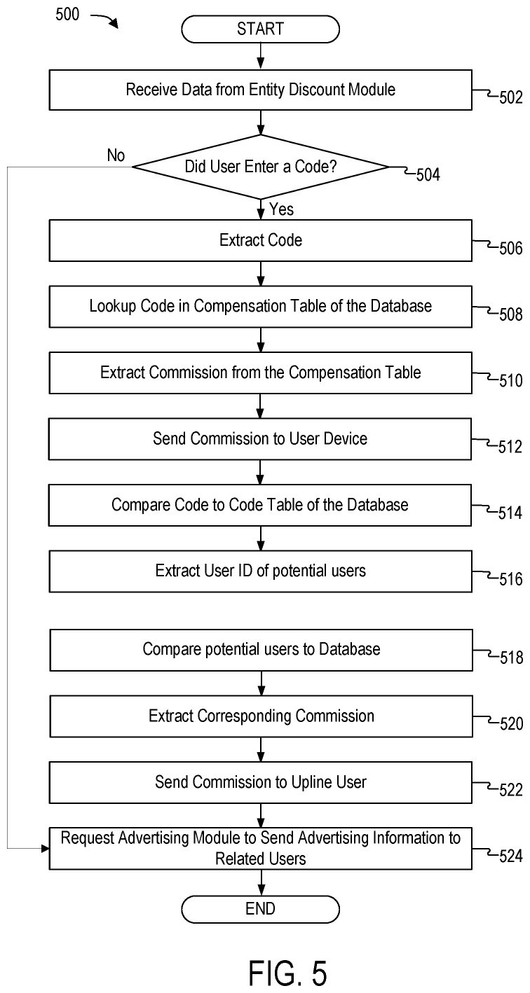

FIG. 5 illustrates a flowchart of another exemplary method performed by a calculation module 204. For example, the method 500 illustrated may be executed by a computing system (e.g., computing system 2100) to determine commissions associated with at least one transaction. In some aspects, the distributor base module 202 may request the calculation module 204 to calculate compensation for the various parties based on updates.

In some aspects, the distributor base module 202 may continuously poll the third-party system (e.g., third-party system 140) for transaction or other updates. In response to the distributor base module 202 detecting an update such as a transaction, the distributor base module 202 may cause computing system to execute the commission module to perform the method 500, which includes receiving the user data from the discount module at step 502. The computing may determine if the user entered a code that is available from the user data at step 504. If the user did enter a code, the computing system extracts the code the user entered at block 506. At block 502, the computing system may look up the extracted code in the compensation database, which contains the various commissions for the different spheres of influence or potential product purchasers/distributors levels as well as the associated code for each of the different sphere of influence levels. The computing system extracts the corresponding commission for the code that was looked up in the compensation database at block 510. In response to retrieving the commission, the computing system sends the commission to the user (e.g., purchaser/distributor). In some aspects, the commission module may track profits, payments to various parties, and track information related to taxes for users enrolled in the MLM system at block 512.

At block 514, the computing system may compare the extracted code to the code database (e.g., in the database 224), which contains the list of users and the code sent to the user's followers. The computing system may then extract the user ID and sphere of influence or potential users associated with the by using the extracted code, at block 516. Then the Admin Network Commission Module compares the extracted sphere of influence or potential users at step 418. The Admin Network Commission Module uses the extracted sphere of influence to extract the corresponding commission compensation table in the database at block 520. The computing system may send the commission to the upline user at block 522. If the user did not enter a code, or after sending the commission at block 522, the computing system may request the advertising module 208 to send advertising information to related users at block 524.

Table 2 below illustrate an example table in the code database for storing data to identify a sphere of influence or potential users. In one illustrative aspect, the code for the followers corresponds to the code that was used when a user purchased a product or item from an entity.

TABLE 2

| | | | Sphere of Influence/ | |
|---|---|---|---|---|
| | | | potential purchaser/ | Code for |
| User ID | ID | Item | distributor | Followers |
| JS1234 | 654123 | Drill | First Participant | 654123-SOI2 |
| HY8569 | 654123 | Drill | 2 | 654123-SOI3 |
| — | — | — | — | — |
| TB4567 | 789654 | Table | First Participant | 897456-SOI2 |
| | | Saw | | |
| EL51346 | 789654 | Table | 2 | 897456-SOI3 |
| | | Saw | | |

Table 3 below illustrates an example table in the compensation database for storing compensation information that is computed based on a transaction. In particular, Table 3 below identifies three different compensation plans based on selling a item (e.g., a drill) having an item ID (e.g., 654123) that identifies corresponding users based on a user ID, a compensation decay rate, a sphere of influence, and a commission. As described above, the calculation module (e.g., calculation module 204) extracts the discount and the compensation plan decay rate and other relevant information form the compensation database to calculate the downline commissions for additional users and the various sphere of influence levels.

TABLE 3

| | | | | | Com- | | |
|---|---|---|---|---|---|---|---|
| | | | | | pen- | Sphere | |
| | | | | | sation | of | |
| 3rd | | | Plan | Assigned | Decay | Influence | Com- |
| Party | ID | Item | ID | User IDs | Rate | Level | mission |
| Home | 654123 | Drill | A | Default | 50% | First | $3.31 |
| Depot | | | | | | Participant | |
| Home | 654123 | Drill | A | Default | 50% | 2 | $1.66 |
| Depot | | | | | | | |
| Home | 654123 | Drill | A | Default | 50% | 3 | $0.83 |
| Depot | | | | | | | |
| Home | 654123 | Drill | A | Default | 50% | 4 | $0.41 |
| Depot | | | | | | | |
| Home | 654123 | Drill | B | JS1234, | 40% | First | $3.31 |
| Depot | | | | HG1991, | | Participant | |
| | | | | BF3483 . . . | | | |
| Home | 654123 | Drill | B | JS1234, | 40% | 2 | $1.32 |
| Depot | | | | HG1991, | | | |
| | | | | BF3483 . . . | | | |
| Home | 654123 | Drill | C | NB3000- | 50% | First | $3.90 |
| Depot | | | | NB3999 | | Participant | |
| Home | 654123 | Drill | C | NB3000- | 50% | 2 | $1.85 |
| Depot | | | | NB 3999 | | | |

In some aspects, the compensation database may include a lottery structure to determine the commissions are paid to users. A lottery structure may to a process that determines an outcome at least partially based on chance. For example, a lottery structure may be raising money by selling number tickets and giving prizes to the holders of the number drawn at random.

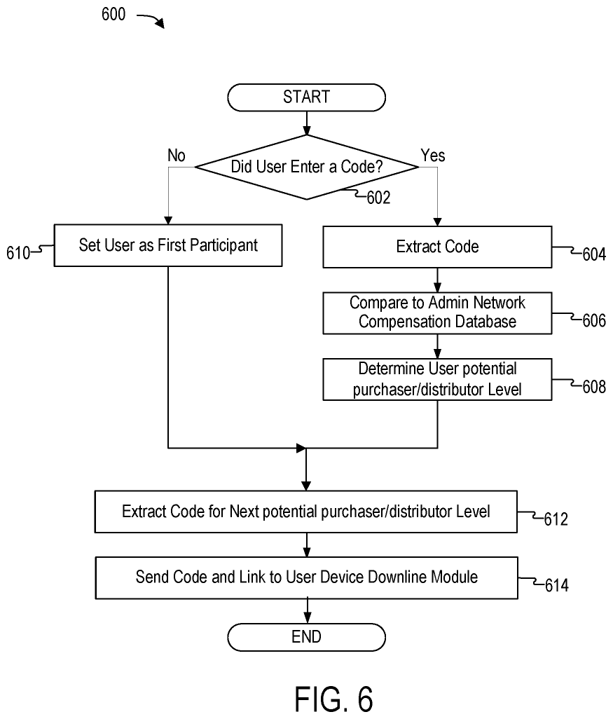

FIG. 6 illustrates a flowchart of an exemplary method performed by an advertising module 208 of the distributor system. For example, the method 600 illustrated may be executed by a computing system (e.g., computing system 2100) to perform advertising functions related to the MLM.

In response to receiving a request to perform an advertising function, the computing system may execute the advertising module 208 to perform the method 500 by determining if the user entered a code at block 602. If it is determined that the user entered a code, the computing system may extract the code at block 604 and then compare the extracted code to the compensation table of the database at block 606. The computing system may determine the user's sphere of influence level at block 608. If it is determined that the vendor did not enter a code at block 602 computing system sets the user as the first participant at block 610. After identifying the user as the first participant or after determining the sphere of influence level at block 608, the computing system extracts the code for the next sphere of influence level or potential purchaser/distributor to provide the user's followers with a code that would allow the followers to join the MLM tree at block 612. The computing system may send the code and the link to the item to the downline module associated with a user device at block 614.

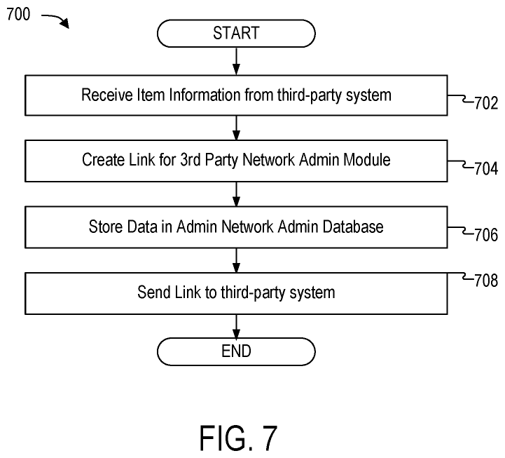

FIG. 7 illustrates a flowchart of an exemplary method performed by a third-party data module (e.g., third-party data module 210) of the distributor system. For example, the method 700 illustrated may be executed by a computing system (e.g., computing system 2100) to perform functions associated with the user data.

In one aspect, the distributor system may receive data from a third-party system (e.g., third-party system 140) and the distributor system may cause a computing system to execute the third party module, which includes receiving item information from the third party system at block 702. The item information may identify an item to be enrolled in the MLM system, the original cost of the item, the discount provided by the entity, the cost of the item with the discount, the compensation plan decay rate, etc. The computing system, at bock 704, may create a link for the item. The computing system may store the received data and the created link in the database at block 706 and send the link to the third-party system at block 808.

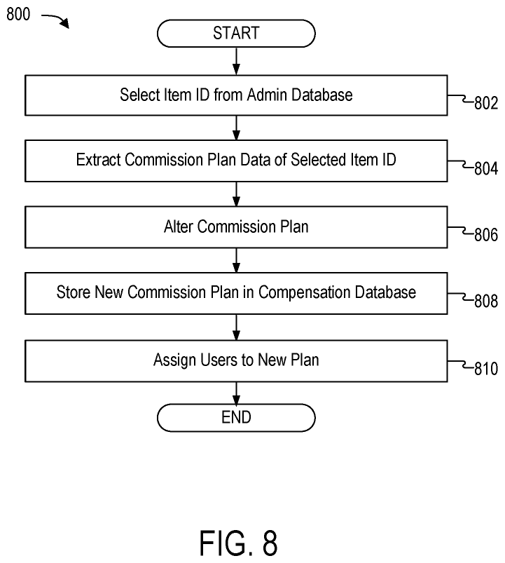

FIG. 8 illustrates a flowchart of an exemplary method performed by a plan generation module of the distributor system (e.g., plan generation module 218) of the distributor system. For example, the method 800 illustrated may be executed by a computing system (e.g., computing system 2100) to generate plans to improve transactions associated with various commission plans.

In some aspects, the plan generation module is configured to generate an alternative commission plan, which will be used in connection with a plan AI module to maximize transactions based on commission efficiency. In some aspects, the plan generation module may be executed periodically, such as every day, or may be executed in response to a trigger that identifies a volume of transaction activity such as a total transaction volume or user transaction volume. Other types of triggers may cause the plan generation module to be executed. In some cases, a minimum number of vendor may need to enroll in into an alternative commission plan before the plan generation module may be executed.

In some cases, the distributor system 200 may cause the computing system to execute the plan generation module and execute the method 800, which includes randomly selecting an item ID from a table in the database of the distributor system at block 802. In some examples, a portion of the available item IDs may be eligible for this selection and users or entities may opt-out of an alternate commission plans for their product or service. In an illustrative example, an item may trigger the initiation of the plan generation module when a number of units is greater than a threshold (e.g., 10,000). The computing system may extract the original commission plan of the selected item ID from the database at block 804. At block 806, the computing system may alter the commission plan by changing one or more parameters of the commission plan. For example, the new commission plan may be generated by altering the decay rate of the original commission plan for example, by decreasing the decay rate from 50% to 45%. The amount of change may be within a variable range or to a set fixed amount. In some cases, the changes the plan can include any suitable parameters, for example, both decay rate and initial commission may be altered. After changing the commission plan, the computing system may store the revised commission plan in the database at block 808. In some aspects, the revised commission plan may include a new unique identifier to distinguish the original plan from the revised plan. The computing system may assign at least one user to the new commission plan at block 810, which are also stored in the database associated with the distributor system.

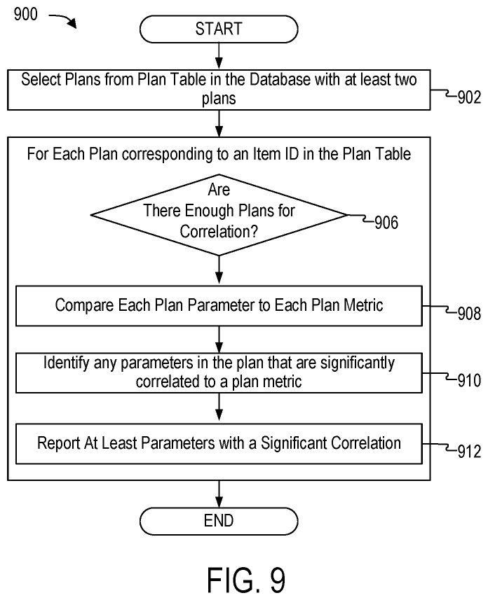

FIG. 9 illustrates a flowchart of an exemplary method performed by a plan analysis module (e.g., plan analysis module 220) of the distributor system. For example, the method 900 may be executed by a computing system (e.g., computing system 2100) to generate plans to improve transactions associated with various commission plans. In some aspects, the plan analysis module is configured to use machine learning (ML) techniques to efficiently identify parameters of a commission plan that maximize the commission to users and entities.

In some cases, the distributor system 200 may cause the computing system to execute the plan generation module and execute the method 900, which includes selecting items from plan table in the database with at least two plans at block 902. In some aspects, the computing may only extract entries in the plan table with the same item ID or updated entries. Each plan corresponds to a unique item that is identified based on the item ID and the plans may be grouped based on the item ID for comparative analysis.

The method 900 includes performing functions in block 904 for each plan corresponding to an item ID in the plan table of the database. In some aspects, block 904 includes determining if there are enough plans for correlation at block 906. The number of plans required may vary based on different characteristics of the item. If there are not enough plans, the iteration associated with that item ID ends. If there are enough plans for a correlation at block 906, the computing system may compare each plan parameter to each plan metric at block 906. In some aspects, the comparison may calculate a correlation coefficient between the selected parameter and each plan metric, which is a measure of the effects of a given plan, for example, revenue per user.

The correlation coefficient is a ratio based on how the two parameters change with respect to one another, if the values of the two parameters change randomly, then the parameter have a correlation coefficient have a value close to zero. If a change in one parameter is reflected by some amount of change in the other then, there is likely a measurable correlation between them and the correlation coefficient may be significant. In some cases, the parameters may be significantly correlated based on execution of an ML model that dynamically groups data in multiple dimensions. For example, the ML model may be a K-means nearest neighbor algorithm that can identify correlated groups of data when there are multiple variables. Other examples of correlation coefficient may be calculated using Pearson correlation, Kendall rank correlation, Spearman correlation, Point-Biserial correlation, any other correlation method, or any combination of methods.

At block 910, the computing system may identify any parameters in the plan that are significantly correlated to a plan metric. In some aspects, the computing system may determine a significant correlation based on comparing the correlation coefficient to a fixed value, for example, if the coefficient is higher than 0.75, then there is a significant correlation.

The computing system may report significant correlations to an operator of the distributor system 200, the operator may then use the correlations to improve existing commission plans or create new commission plans. In some embodiments, this reporting may be done via a GUI, email, text, a printout, another method of communication, or any combination of methods. In an aspect, the correlations may be stored in a database for later access and comparative analysis and the ML models improve.

The distributor system may include a storage device for storing the plan data. In one illustrative example, the plan data may be stored in a plan table within the database 224, and is illustrated in Table 4 below.

TABLE 4

| | | | | Com- | | | | | New |
|---|---|---|---|---|---|---|---|---|---|
| | | | Assigned | pensation | Initial | Profit | Revenue | Sales | Users |
| Item | | Plan | User | Delay | Com- | per | Per | Volume | per |
| ID | Item | ID | IDs | Rate | mission | day | day | per day | week |
| 654123 | Drill | A | Default | 50% | $3.31 | $30.20 | $341.63 | 8.6 | 2.4 |
| 654123 | Drill | B | JS1234, | 40% | $3.31 | $44.58 | $368.37 | 8.9 | 2.4 |
| | | | HG1991, | | | | | | |
| | | | BF3483... | | | | | | |
| 654123 | Drill | C | NB3000 - | 50% | $3.90 | $16.44 | $285.48 | 7.5 | 2.9 |
| | | | NB3999 | | | | | | |

The plan table may contain data associated with each plan such as an item ID, name of the item, a plan ID, assigned user identifiers, a compensation delay rate, an initial commission, profit per day, revenue per day, sales volume per day, and new users that are recruited by users assigned to the plan per week. In Table 4 above, three plans are illustrated for a single item ID (654123 with a unique plan ID that identifies users that are assigned to the plan. For example, “Default” for the user IDs indicates any user not assigned to another plan. Thus, users NB3000-NB3999 are assigned to the commission plan C in Table 4 above. In this case, each plan can have a different decay rate, for example, 50%, and a different initial commission, for example, $3.31 or $3.90. Based on the data recorded in the plan table, the operator of the distributor network 200 may be able to maximize transaction performance.

FIG. 10 shows a block diagram of an exemplary user device 1000 configured to create transactions based on the distributor system. In some aspects, the user device 1000 may be a device that is used by an individual user who generates leads and engages with potential customers and other downline customers to sell products or services. For example, the user device 1000 may be an individual's mobile phone or a laptop and is configured to perform one or more of the methods or processes described herein. In one aspect, the user device 1000 may be implemented in whole or in part by at least one computing system, such as the computing system 2100. The user device 1000 may include at least one communication module that is configured to communicate over a public or private network, either through wired or wireless techniques, to exchange information to perform the various methods described herein.

The user device 1000 includes an entity purchase module 1002 for interacting with another entity's system (e.g., third-party system 140) or generating transactions, a downline module 1004 for receiving information from the distributor system and passing that information to downline users, a social media service module 1006 for connecting and interacting with social media (e.g., Facebook, Instagram, TikTok, etc.), a network login module 1008 for connecting with various services provided by the distributor system 200, and a database 1010 for storing various information associated with the user device.

In some aspects, at least some of the modules 1002, 1004, 1006, and 1008 are implemented at least in part as software stored in a memory. For example, portions of one or more of the modules 1002, 1004, 1006, and 1008 can be implemented as non-transitory instructions (or “code”) executable by at least one processor to perform the functions or operations of the respective engine. In some cases, at least some of the modules 1002, 1004, 1006, and 1008 may be implemented by a circuit, such as an ASIC or programmable circuit such as a FPGA.

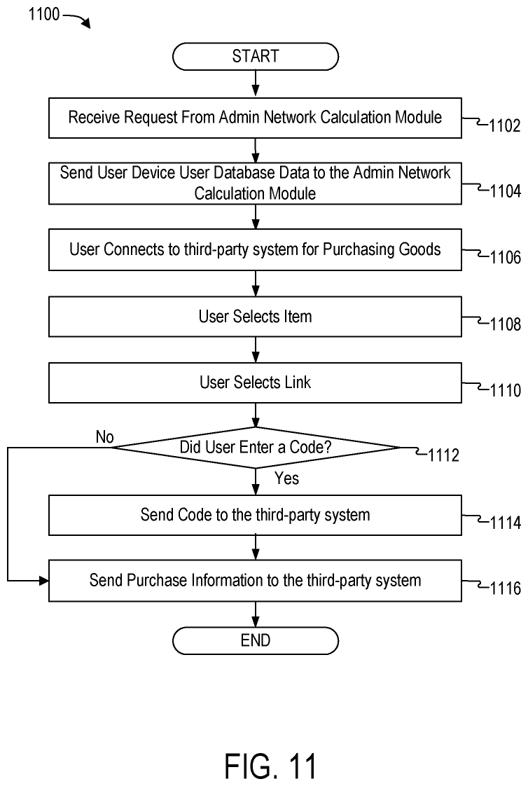

FIG. 11 illustrates a flowchart of an exemplary method 1100 performed by a purchase module (e.g., purchase 1002). For example, the method 1100 may be executed by a computing system (e.g., computing system 2100) to provide user data to the distributor system and the purchase goods or services within the MLM.

In some aspects, the computing system may execute the purchase module to perform the method 1100, which includes receiving a request from the calculation module (e.g., calculation module 204) for the data stored in the database 1010. In particular, the distributor system may request information of associated users (e.g., followers) of a user associated with a user device. At block 1104, the computing device sends the data to the calculation module 204.

In some aspects, the user may request to purchase goods and the purchase module may cause the computing device connect to a third-party system (e.g., third-party system 140) and receive items available from the third-party system at block 1106. The user may cause the computing system to select an item from the third-party system at block 1108, and then selects a link from the 3rd Party Network at block 1110. In some aspects, the computing system can provide a user interface that allows a user to enter a code at block 1112. If the user enters a code, the computing system may send the code to the third-party system at block 114. After sending the code, or after determining that a code was not entered at block 1112, the computing device may send purchase data to the to the third-party system.

In some embodiments, the purchase data may be a list of items to purchase, address, billing information, etc. In some embodiments, the purchase data may include payment information such as credit card information, or various other payment systems (e.g., PayPal, Venmo, etc.).

Table 5 below illustrates an example of a user device database (e.g., database 1110), which contains the user's followers as well as the follower's information. The user device database contains the user's ID, the followers' user's ID, the code provided to the followers, the follower's e-mail address, the follower's phone number, the follower's address. In some aspects, the user device database may contain the follower's social media information (e.g., Twitter, Instagram, Facebook, etc.) and may also contain social media plug-ins for enhanced marketing or social media aggregators. A social media plug-in for enhanced marketing may refer to sharing content with other people through social media platforms, for example, a share or like button. The user device database may contain payment information (e.g., bank accounts, credit card information, PayPal, Venmo, etc.), and a user ID or ID Enrollment that refers to a participant enrolling in an MLM product tree through an ID, which is unique to each participant in the MLM system. In some cases, social media aggregators may allow a person to collate posts and updates from many different social media feeds to create an organized view of social posts on a specific topic and are used to display user-generated content on social walls.

TABLE 5

| User | Follower | Code for | | Follower | Follower |
|---|---|---|---|---|---|
| ID | ID | Followers | Follower E-mail | Phone | Address |
| JS1234 | HY8569 | 654123-SOI2 | HY8569@gmail.com | 781-654-8972 | 123 Main St |
| | | | | | Boston, MA |
| JS1234 | IT8527 | 654123-SOI2 | IT8527@yahoo.com | 231-456-7891 | 58 Elm Str, |
| | | | | | Burlington, VT |
| JS1234 | RW4569 | 654123-SOI2 | RW4569@gmail.com | 654-987-3217 | 96 2^{nd} Ave, |
| | | | | | Salt Lake City, |
| | | | | | UT |

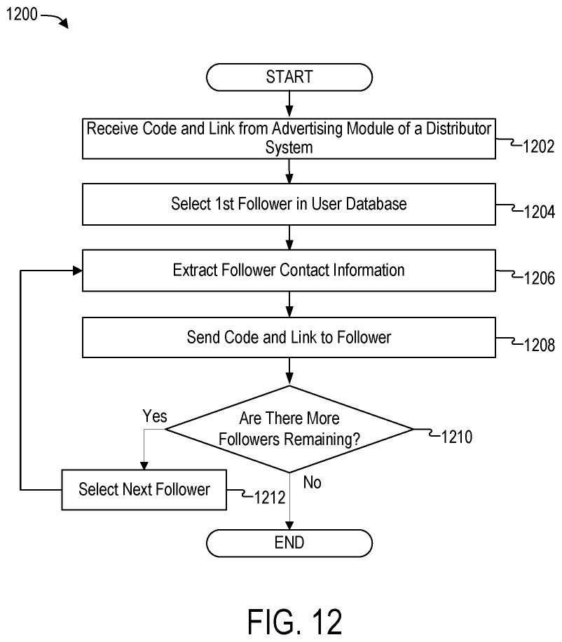

FIG. 12 illustrates a flowchart of an exemplary method 1200 performed by a downline module (e.g., downline module 1004). For example, the method 1200 illustrated may be executed by a computing system (e.g., computing system 2100) to generate downline users. In some aspects, the computing system may receive code and link from advertising module 208 of a distributor system at block 1202.

In some aspects, the computing system may receive the code and the link from the advertising module 208 at block 1202. The computing system may select the first follower in the user device database at block 1204. The computing system may extract the contact information of the selected follower from the user device database at block 1206. Then the computing system may send the code and link to the contact information at block 1208. In some aspects, at block 1208, the code and link may be shared on social media sites, such as Twitter, Instagram, Facebook, etc. for the followers of the user to receive the code and link.

The User Device Downline Module determines if there are more followers remaining in the user device database at block 1210. If it is determined that there are more followers stored in the user device database, the computing system selects the next user stored in the user device database at block 1212 and returns to block 1206 to send the next contact the code and link. If the computing system determines that there are no more followers remaining in the user device database then the process ends.

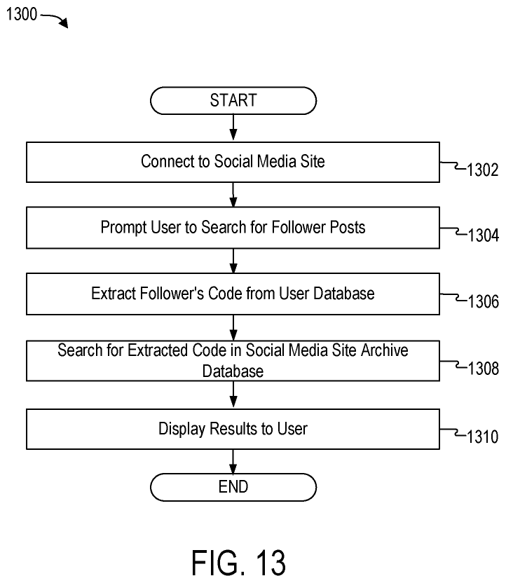

FIG. 13 illustrates a flowchart of an exemplary method 1300 performed by a social media search module (e.g., a social media search module 1006). For example, the method 1300 illustrated may be executed by a user device that includes a computing system (e.g., computing system 2100) to link MLM operations with social media services.

In some aspects, the social media search module may be initiated by the user via the user device. For example, the user may be able to interact with a user interface (e.g., a button) that will initiate the social media search module. In some aspects, the computing system, in response to receiving the input on the user interface, may connect to a social media service (e.g., Facebook, TikTok, etc.) at block 1302. The computing system may prompt the user for required login information depending on the security of the social media service. In some aspects, the connection to the Social Media Site may be facilitated by an API. The computing system may prompt the user to search for follower posts at block 1304. If a follower is downline of the user in more than one single-product tree then the user may be required to specify which product they want the posts to be related to, otherwise the computing system may return all posts from that user concerning any product. In some other aspects, the computing system can search for all posts and all products and will use natural language processing and image processing to determine which correlate posts to products. The computing device then prompts the user to confirm that posts and products are selected. In some other aspects, the computing device may use the user device database or other databases to identify related products.

The computing system may, at block 1306, extracts the codes associated with followers from the user device database. After extracting the codes, computing system searches for instances of the extracted code in the content of posts stored in the social media service 1308. In some aspects, the social media service can expose an endpoint through an API to allow the user to search available content in an archive database (e.g., archive database 162 in FIG. 1). The computing system displays the results of the search to the user via the user device or the results may be sent to the user via another means of communication, for example, email or SMS text at block 1310. The social media search module may prompt the user to begin another search before ending. If the user does want to begin another search, the social media search module returns to prompting the user for a follower to search.

In some aspects, the archive database may contain records of all posts available to the user or all posts publicly available on the social media service. An example of an archive database is illustrated in Table 6 below and includes information such as a post ID that uniquely identifies the post, for example, “U5PiOgWrbElOb941” which may also be used to direct to the post via a URL, for example, “https://www.facebook.com/U5PiOgWrbElOb941/”. The archive database may include a time and date that the post was made, for example, 4/5/2020 8:38:23 AM. The archive database may include the content of the post in a compressed or easily searchable format such as XML, HTML, markdown, and so forth. The database may include other information and have any type of relationship (one to one, one to many, etc.) with other entities within the social media service to allow the content to be available to other users.

TABLE 6

| Post ID | Time | Content |
|---|---|---|
| U5PiOgWrbElOb941 | Apr. 5, 2020 | <blockquote class=“post”> |
| | 8:38:23 | <p lang=“en” dir=“ltr”>Why do we need <a |
| | | href=“https://example.com/”> ... |
| Es3cfFqJiW0UNHae | Apr. 5, 2020 | <blockquote class=“post”> |
| | 8:38:23 | <p lang=“en” dir=“ltr”>Just got this new drill! Use this |
| | | code to get yours: 654123- |
| | | SOI3 ... |
| A4OwULiAwdv56jxt | Apr. 5, 2020 | <a |
| | 8:38:24 | href=“https://homedepot.com/drill140/discountcode=6541 |
| | | 23-SOI4”> |
| | | <img src = “mydrillpic.jpeg”> |
| | | </a> |

FIG. 14 illustrates a flowchart of an exemplary method 1400 performed by a distributor system to permit a user device to access various user modules of the distributor system. For example, the method 1400 illustrated may be executed by a distributor system (e.g., distributor system 110) that includes a computing system (e.g., computing system 2100).

In some aspects, the computing system may receive login credentials from a user device at block 1402. Credentials may include a username and password, and may include additional authentications such as a second step (e.g., a random code sent do a different device) to provide extra security. The computing system may determine if the credentials are valid at block 1404. If the login was unsuccessful, the computing system may send an authentication denial to the user device at block 1406 and ends the method 1400. The user may again attempt to login and initiate the method again after the denial.

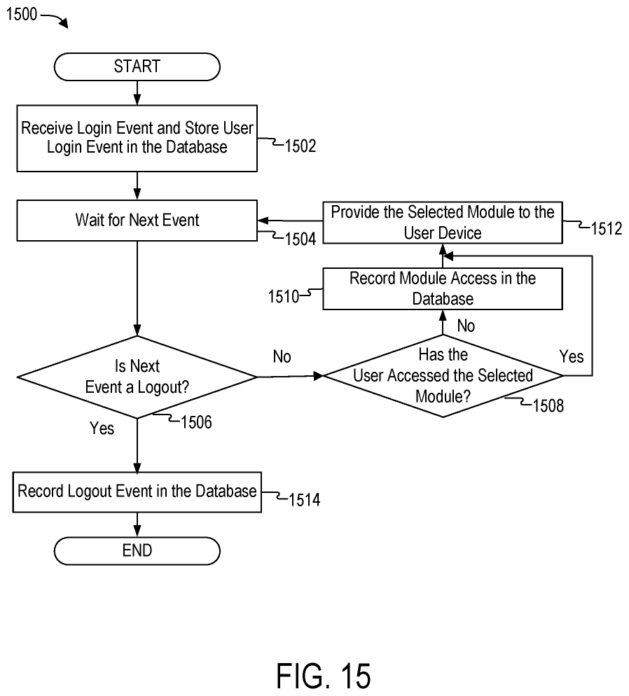

If the login was successful, the computing device sends a confirmation to the user device at block 1408 and the user device connects to the distributor system (e.g., distributor system 110) and activates a user activity module at block 1410, which is described below with reference to FIG. 15. After receiving the confirmation, the user can access some or all of the various user modules at block 1412. In response to selecting a user module, the computing system can provide functionality to the selected module at block 1414. In some aspects, the computing system can provide server-side rendering on the module and provide a static or semi-static user interface to the user device, or may provide a client-side rendered user interface to the user device.

FIG. 15 illustrates a flowchart of an exemplary method 1500 performed by a user activity module of distributor system. For example, the user activity module may cause a computing system (e.g., computing system 2100) to execute the method 1500 after a user has logged in.

In some aspects, the user activity module (e.g., user activity module 214) is configured to receive a login event including authentication information and store the user login event (e.g., the user ID, the current time, and an event instance time) in a database (e.g., database 224). For example, an authentication module can be scaffolded into the database 224 using various command line interface (CLI) tools that implement various authentication schemes such as OAuth.

At block 1504, the computing system may wait until a next event is received from the user device. When the next event is received, the computing system may determine if that next event corresponds to a logout event at block 1506. If the event does not correspond to a logout, the computing system determines if the user has access the selected user module at block 1508. In some cases, the determination of access the selected user module is per login session to identify a frequency that a particular module is executed. If the user has not access the selected module, the computing system may record the module access in a database at block 1510. Table 7 below illustrates an example user activity database that identifies various user events such as login, access time to modules, and so forth. After recording the module access, or after determining the user has previously accessed the module, the computing system may provide the selected module to the user device at block 1512. As noted above, the selected module may be rendered using either server-side rendering or client-side rendering. In some cases, the computing system may be configured to receive user inputs during the selected module and may be configured to record user events. After the module is provided to the user device, the method 1500 returns to block 1504 and waits for a next module selection event.

TABLE 7

| User Id | Event | Timestamp |
|---|---|---|
| JS1234 | Login | 3/21/2022 8:55:00 AM |
| JS1234 | Access Ad Builder Module | 3/21/2022 8:56:20 AM |
| JS1234 | Access Smart Link Module | 3/21/2022 9:44:08 AM |

Returning to block 1506, if the next event is a logout event, the computing system may record the logout event in the database at block 1514. In this case, the user session may end. In other cases, the user session can expire due to an inactivity timeout and the user would login again the access the various user modules.

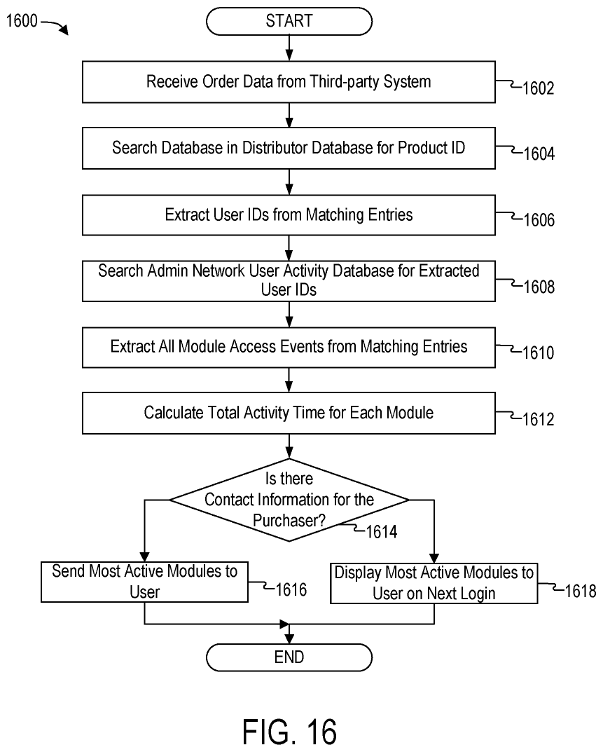

FIG. 16 illustrates a flowchart of an exemplary method 1600 performed by a suggested features module of user system. For example, the suggested features module (e.g., suggested features module 216) may cause a computing system (e.g., computing system 2100) to execute the method 1600 after a user has logged in.

In some aspects, a computing system, which is executing the suggested features module, receives order data from the third-party system (e.g., third party system 140) at block 1602. The computing system may search the database of the distributor system (e.g., database 224) for the product ID at block 1604 and extracts user IDs from the matching entries. That is, at block 1604, the computing system may identify the user IDs for every user who has purchased a product with the same product ID as the user who placed the order. In some cases, the computing system may filters users based on various criteria (e.g., purchases more than a year ago). The computing system searches the database (e.g., a user activity table in the database 224) for each extracted user ID at block 1608.

The computing system may then extract module access events and the associated timestamp from each matching entry to collect all user module activity for users that have purchased the same product as the user who placed the order at block 1610. The computing system may then calculate the total activity time for each module at block 1612 by, for example, by calculating the difference between the time access event for one module and the next in time. For example, if a user accessed the jurisdiction module at 9:00 AM and the next activity for that user was accessing the review module at 10:00 AM, then the user is assumed to have 1 hour of activity time in the jurisdiction module. Each calculated activity time for a module may be added together to get the total value. The calculation may also take into account factors such as idle time spend in a module, how much commission a user has made from the product, when that user purchased the product, how often a module was accessed, which modules are synergistic, user ratings of a module, and any other factor which may be relevant to the utility of a module.

The computing system may determine if there is the contact information for the user at block 1614. Contact information may be contained within the order data or may be associated in a database with the user ID contained in the order data. If there is the contact information for the user, the computing system sends the user a notice of which modules may be the most helpful in distributing the product to others based on the activity of other users at block 1616. This notice may only include a subset of all modules, for example, the top five highest activity levels. If there is no contact information for the user at block 1614, the computing system waits until the user logs into a portal provided by the distributor system (e.g., distributor system 140) and then displays to the user a notice of which modules may be the most helpful in distributing the earlier purchased product to others based on the activity of other users at block 1618. This notice may only include a subset of all modules, for example, the top five highest activity levels.

FIG. 17 shows a block diagram of an exemplary third-party system 1700 configured to enroll products and services into a distributor system. In some aspects, the third-party system 1700 is configured to perform one or more of the methods or processes described herein. In one aspect, the third-party system 1700 may be implemented in whole or in part by at least one computing system, such as the computing system 2100 illustrated in FIG. 21. The third-party system 1700 may include at least one communication module that is configured to communicate over a public or private network, either through wired or wireless techniques, to exchange information to perform the various methods described herein. In some aspects, the third-party system 1700 can be a single device, or can be implemented in a container system (e.g., Docker, Kubernetes) and implement a plurality of microservices that can dynamically create and remove separate containers across different geographical locations to enhance service.

In some aspects, the third-party system 140 is associated with a legal entity (e.g., a corporation, a limited liability corporation, etc.) that is engaged to sell products or services. For example a third-party may have a primary business function such as retail stores including stores that sell consumer goods, services, franchises, service networks (e.g., Angi), large box stores, or e-commerce sites that allow e-commerce sales and may include an e-commerce shopping cart, that offers items to users at a discount, such as a product discount that may use an MLM to distribute goods or services. In some aspects, the third-party system 140 may provide business-to-business (B2B) services (e.g., temporary staffing, recruiting, etc.) or B2B products (e.g., medical test equipment, manufacturing equipment, raw materials for manufacturing processes, etc.).

An example third-party system 1700 is a retailer (e.g., a person or other legal entity corresponding to a business entity) that sells goods to the public for use or consumption rather than for resale. A retailer may refer to a big box store that refers to physically large retail establishment (e.g., 50,000 square feet), usually, part of a chain of stores offers a variety of products to its customers and achieve economies of scale by focusing on large sales volumes. Because volume is high, the profit margin for each product can be lowered, which results in very competitively priced goods. Business in this context is defined as an order placed by the buyer or price and terms of sale negotiated.

In some aspects, a third-party system can also be an e-commerce business includes a software platform that implements an e-commerce shopping cart to assist visitors to make purchases online. Upon checkout, the software platform calculates the total of the order, including shipping and handling, taxes, and other parameters the owner of the site has previously set. In some aspects, a software platform may be a collection of various modules (e.g., a style framework for providing a consistent user interface), services (e.g., payment, authentication, etc.), and a framework (e.g., React, Angular, etc.) that provides a cohesive user experience.

The third-party system 1700 may include a base module 1702 that receives a selection of a link by a user, receives the user data, and requests a discount module 1706 to identify a discount for a transaction including an item. The third-party system 1700 also includes a distributor data module 1704 to connect to the distributor system (e.g. distributor system 200) to sends data for the items to be purchased from the third-party system 1700, receives a link from the distributor system, and store the link in the in a database 1708.

In some aspects, at least some of the modules 1702, 1704, and 1706 are implemented at least in part as software stored in a memory. For example, portions of one or more of the modules 1702, 1704, and 1706 can be implemented as non-transitory instructions (or “code”) executable by at least one processor to perform the functions or operations of the respective engine. In some cases, at least some of the modules 1702, 1704, and 1706 may be implemented by a circuit, such as an ASIC or programmable circuit such as an FPGA.

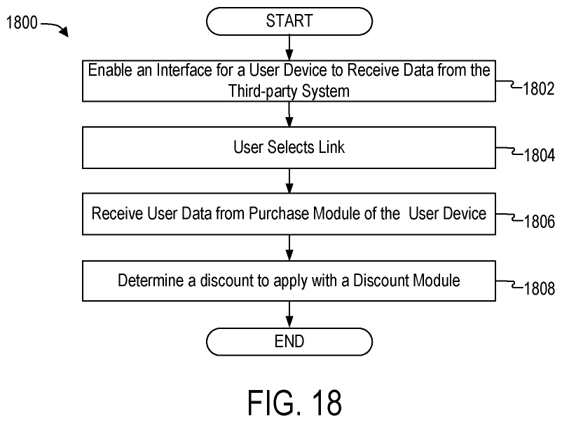

FIG. 18 illustrates a flowchart of an exemplary method 1800 performed by a third-party base module of third-party system. For example, the third-party base module (e.g., third-party base module 1702) may cause a computing system (e.g., computing system 2100) to execute the method 1800.

In one aspect, the computing system, while executing the third-party base module, is configured to enable an interface for a user device to receive data from the third-party system. to select a link at block 1802. In some aspects, the third-party module may be a server with an API endpoint that allows an application on a user device to receive data and select a link in the data. In other aspects, the third-party module may execute a server and the third-party module provides a document (e.g., a web page) to the user device with a link to an item of the third-party system.

At block 1804, a user of a user device selects a link in the data from the third-party system. In one aspect, the selecting of the link may be a combination of actions to a request to purchase an item associated with that link (e.g., the user adds an item to a cart and then proceeds through a checkout process). In response to the selection of the link, at block 1806, the computing system may receive data from a purchase module of the user device and includes, for example, an identification of the purchased item, invoicing information, shipping information, a quantity, etc. In response to receiving data from the purchase module, the computing system may determine a discount to apply by executing a discount module (e.g., discount module 1706).

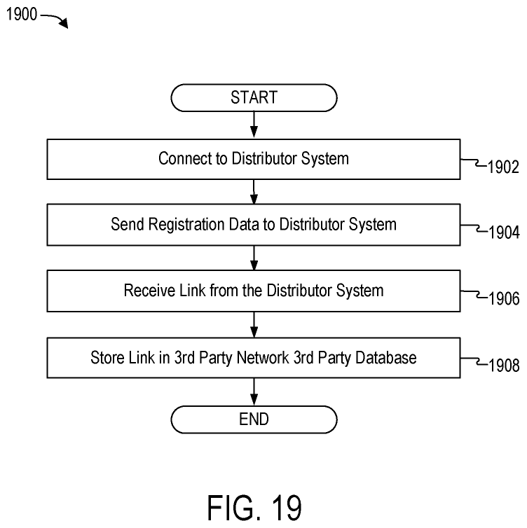

FIG. 19 illustrates a flowchart of an exemplary method 1900 performed by a distributor registration module. For example, the distributor registration module (e.g., distributor registration module 1704) may cause a computing system (e.g., computing system 2100) to execute the method 1900 to allow the third-party to register products or services within the distributor system 110.

In some aspects, an agent of the third-party system (e.g., third-party system 140) may register or enroll a product or service by executing, for example, a user interface on a computing system available to agents of the third-party system. The computing system may connect to the distributor base module at block 1902. After an agent provides necessary input to register a product or service, the computing system sends the information that is stored in a database (e.g., database 1708) to the distributor system. In response to the information, the distributor system makes the product or service available within the distributor system, creates proprietary information associated with the product or service such as a link, and returns the proprietary information to the third-party system. The computing system of the third-party system receives the proprietary information including a link for the item distributor system 1110 at block 1906 and stores the link in the database of the third-party system (e.g., database 1908).

Table 9 below illustrates an example database that contains the information about the items enrolled in the MLM system as well as the link created by the distributor system. In one aspect, the example database contains the item ID, the item, the original cost of the item, the discount provided by the 3rd Party for the item, the cost of the item with the discount, the compensation plan decay rate provided by the third-party, and the link.

TABLE 9

| | | | | Dis- | Com- | |
|---|---|---|---|---|---|---|
| Item | | Original | Dis- | count | pensation | |
| ID | Item | Cost | count | Cost | Decay Rate | Link |
| 654123 | Drill | $59.00 | 15% | $50.15 | 50% | HDDrill654123 |

In some aspects, the database may include additional detail necessary to implement various functions associated with the third-party, such as exchange rates for product returns, marketing information, airline sky miles, and so forth. For example, the marketing information may identify various advertisements such as advertisements proffered by the distributor system 110, or advertisements provided by the third-party. One example of an advertisement is an as seen on TV sale that refers to a generic nameplate for products advertised on television for direct-response mail-order through a toll-free telephone number. The marketing information may refer to any marketing, advertising, or promotional materials developed by or for a license (or subject to licensee's approval) that promote the sale of the licensed product or service, including but not limited to, television, radio and online advertising, point of sale materials (e.g. posters, counter-cards), packaging advertising, print media and all audio or video media.

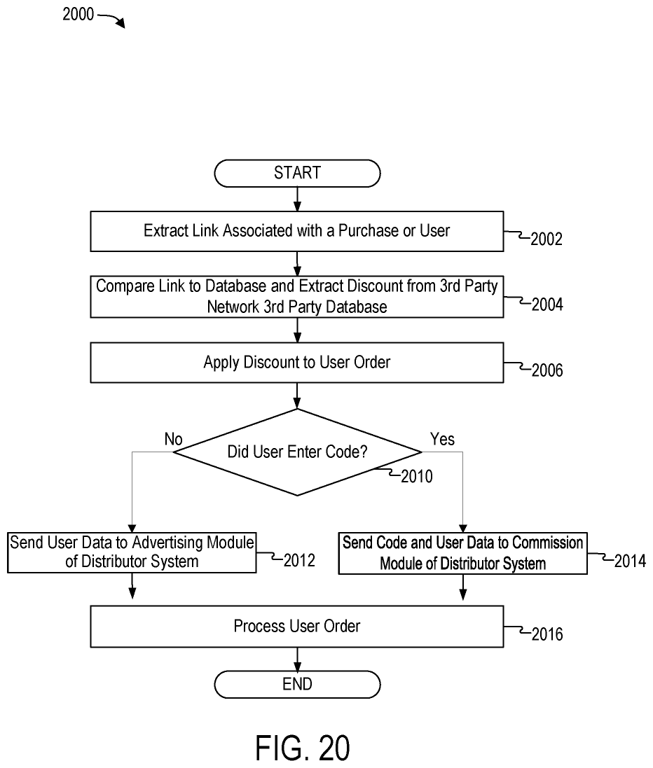

FIG. 20 illustrates a flowchart of an exemplary method 2000 performed by a discount module of third-party system. For example, the discount features module (e.g., discount module 1706) may cause a computing system (e.g., computing system 2100) to execute the method 2000 before, after, or during a transaction.

In some aspects, the third-party may receive a purchase from a user device, as illustrated in FIG. 18, and invoke the discount module to cause a computing system to extract the link associated with a purchase or a user at block 2002. At block 2004, the computing system may compare link to the database (e.g., database 1708) and extract a discount associated with a user. The computing system compares the extracted link to the 3rd database and extracts the corresponding discount using the extracted link at block 2004. Then the computing system applies the extracted discount to the user's order at block 2006.

At block 2010, the computing system determines if the user entered a code. If it is determined that the user did not enter a code, the computing system sends the user data to the distributor system 110 for use in the advertising module 208. If it is determined that the user entered a code, the computing system sends the code and the user data to the commission module of the distributor system. The distributor system then processes the user's order at block 2016 based on the target module and sends the order data to the suggested features module to use the order as part of data learning techniques described herein. Order data may include the product ID and a user ID or other contact information for the user such as an email address.

FIG. 21 is a diagram illustrating an exemplary system 2100 for implementing certain aspects of the present technology. In particular, FIG. 21 illustrates an example of computing system 2100, which can be for example any computing device making up internal computing system, a remote computing system, a camera, or any component thereof in which the components of the system are in communication with each other using connection 2105. Connection 2105 can be a physical connection using a bus, or a direct connection into processor 2110, such as in a chipset architecture. Connection 2105 can also be a virtual connection, networked connection, or logical connection.

In some aspects, computing system 2100 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example computing system 2100 includes at least one processing unit (CPU or processor) 2110 and connection 2105 that couples various system components including system memory 2115, such as read-only memory (ROM) 2120 and random access memory (RAM) 2125 to processor 2110. Computing system 2100 can include a cache 2112 of high-speed memory connected directly with, in close proximity to, or integrated as part of processor 2110.

Processor 2110 can include any general purpose processor and a hardware service or software service, such as services 2132, 2134, and 2136 stored in storage device 2130, configured to control processor 2110 as well as a special-purpose processor where software instructions are incorporated into the actual processor design. Processor 2110 may essentially be a completely self-contained computing system, containing multiple cores or processors, a bus, memory controller, cache, etc. A multi-core processor may be symmetric or asymmetric.

To enable user interaction, computing system 2100 includes an input device 2145, which can represent any number of input mechanisms, such as a microphone for speech, a touch-sensitive screen for gesture or graphical input, keyboard, mouse, motion input, speech, etc. Computing system 2100 can also include output device 2135, which can be one or more of a number of output mechanisms. In some instances, multimodal systems can enable a user to provide multiple types of input/output to communicate with computing system 2100. Computing system 2100 can include communications interface 2140, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a Bluetooth® wireless signal transfer, a BLE wireless signal transfer, an IBEACON® wireless signal transfer, an RFID wireless signal transfer, near-field communications (NFC) wireless signal transfer, dedicated short range communication (DSRC) wireless signal transfer, 802.11 WiFi wireless signal transfer, wireless local area network (WLAN) signal transfer, Visible Light Communication (VLC), Worldwide Interoperability for Microwave Access (WiMAX), IR communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 2140 may also include one or more Global Navigation Satellite System (GNSS) receivers or transceivers that are used to determine a location of the computing system 2100 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 2130 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, RAM, static RAM (SRAM), dynamic RAM (DRAM), ROM, programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

The storage device 2130 can include software services, servers, services, etc., that when the code that defines such software is executed by the processor 2110, it causes the system to perform a function. In some aspects, a hardware service that performs a particular function can include the software component stored in a computer-readable medium in connection with the necessary hardware components, such as processor 2110, connection 2105, output device 2135, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as CD or DVD, flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces can be configured to communicate and/or receive wired and/or wireless data, including data according to the 3G, 4G, 5G, and/or other cellular standard, data according to the Wi-Fi (802.11x) standards, data according to the Bluetooth™ standard, data according to the IP standard, and/or other types of data.

The components of the computing device can be implemented in circuitry. For example, the components can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but may have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as RAM such as synchronous dynamic random access memory (SDRAM), ROM, non-volatile random access memory (NVRAM), EEPROM, flash memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more DSPs, general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

What is claimed is:

1. A method of providing dynamic commission plans, the method comprising:
receiving a transaction request associated with an item provided from a third party, the transaction request associated with a hyperlink;
identifying a user associated with the transaction request based on information embedded in the hyperlink;
identifying a commission plan for the item from a plurality of commission plans for the item, wherein the commission plan is configured by the third party; and
determining a commission associated with the user based on the commission plan associated with the item.

2. The method of claim 1, further comprising:
determining that the item associated with the third party has met a threshold of transactions;
creating an alternative commission plan for transactions associated with future transactions of the item;
identifying at least one user to assign to the alternative commission plan based on the at least one user registering for alternative commission plans;
comparing transactions associated with the alternative commission plan to a default commission plan and identifying parameters that affect transactions associated with the item; and
generating a report based on the parameters.

3. The method of claim 2, wherein comparing the transactions comprises clustering transactions of the item based on different parameters associated with each commission plan and determining a correlation between each cluster and at least one parameter.

4. The method of claim 3, wherein a parameter affects transactions associated with the item when the correlation is greater than a threshold.

5. The method of claim 2, wherein an entity associated with the item configures the threshold of transactions to trigger the alternative commission plan.

6. The method of claim 2, wherein comparing transactions associated with the alternative commission plan to the default commission plan comprises:
grouping transactions based on a corresponding commission plan; and
comparing one or more objective metrics associated with each parameter of each commission plan.

7. The method of claim 1, further comprising:
providing a portal to a device of the user for researching transactions and related materials associated with the item;
identifying at least one module related to the user device based on a transaction linked to the user; and
providing a display of the at least one module at the user device.

8. The method of claim 7, wherein identifying the at least one module is further based on a total activity time in each module for other users that have purchased the item.

9. The method of claim 7, further comprising recording a timestamp of a request to access a module associated with the portal.

10. The method of claim 1, further comprising transmitting a follower code of another user that is linked to the user for researching transactions, wherein a user device of the user is configured to identify content on a social media service related to preferences associated with the other user.

11. An apparatus for providing dynamic commission plans, the apparatus comprising:
a communication interface that communications over a communication network to receive a transaction request associated with an item provided from a third party, the transaction request is associated with a hyperlink; and
a processor that executes instructions stored in memory, wherein the processor executes the instructions to:
identify a user associated with the transaction based on the hyperlink;
identify a commission plan for the item from a plurality of commission plans for the item, wherein the commission plan is configured by the third party; and
determine a commission associated with the user based on the commission plan associated with the item.

12. The apparatus of claim 11, wherein the processor executes further instructions to:
determine that the item associated with the third party has met a threshold of transactions;
create an alternative commission plan for transactions associated with future transactions of the item;
identify at least one user to assign to the alternative commission plan based on the at least one user registering for alternative commission plans;
compare transactions associated with the alternative commission plan to a default commission plan and identify parameters that affect transactions associated with the item; and
generate a report based on the parameters.

13. The apparatus of claim 12, wherein the processor compares the transactions by clustering transactions of the item based on different parameters associated with each commission plan and determine a correlation between each cluster and at least one parameter.

14. The apparatus of claim 13, wherein a parameter affects transactions associated with the item when the correlation is greater than a threshold.

15. The apparatus of claim 12, wherein an entity associated with the item configures the threshold of transactions to trigger the alternative commission plan.

16. The apparatus of claim 12, wherein the processor compares transactions associated with the alternative commission plan to the default commission plan by:
grouping transactions based on a corresponding commission plan; and
comparing objective metrics associated with each parameter of each commission plan.

17. The apparatus of claim 11, wherein the processor executes further instructions to:
provide a portal to a device of the user for researching transactions and related materials associated with the item;
identify at least one module related to the user device based on a transaction linked to the user; and
provide a display of the at least one module at the user device.

18. The apparatus of claim 17, wherein the at least one module is identified based on a total activity time in each module for other users that have purchased the item.

19. The apparatus of claim 17, wherein the processor executes further instructions to record a timestamp of a request to access a module associated with the portal.

20. The apparatus of claim 11, wherein the processor executes further instructions to transmit a follower code of another user that is linked to the user for researching transactions, wherein a user device of the user is configured to identify content on a social media service related to preferences associated with the other user.
